(19) United States
(12) Patent Application Publication
(10) Pub. No.: US 2012/0214012 A1
(43) Pub. Date: Aug. 23, 2012

(54) EXTENDED WAX COMPOSITION AND COMPOSITE PANELS PREPARED THEREWITH

(76) Inventors: Gregory D. Briner, Springfield, OR (US); Eduardo Romero, Porter, TX (US); Carlos E. Nuila, Lake Jackson, TX (US)

(21) Appl. No.: 13/400,297

(22) Filed: Feb. 20, 2012

Related U.S. Application Data
(60) Provisional application No. 61/444,907, filed on Feb. 21, 2011.

(51) Int. Cl. B32B 21/08; C08L 61/10; C08L 29/04

(52) U.S. Cl. 428/541; 524/557; 524/509

(57) ABSTRACT

A wax extender may be employed in the manufacture of particle board, and oriented strand board to reduce the content of the wax in favor of a copolymer prepared by copolymerizing vinyl acetate with a hydrophobic reactive comonomer. The hydrophobic reactive comonomer may have the general formula:

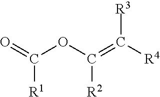

wherein R¹ is a hydrophobic group having from about 4 to about 25 carbons; and R², R³ and R⁴ are independently hydrogen or a methyl group subject to the limitation that at least one of these is hydrogen.

### RELATED APPLICATION DATA

This application claims benefit to U.S. Provisional Application No. 61/444,907, filed Feb. 21, 2011, of which the entire contents of the application are incorporated by reference herein.

### FIELD OF THE INVENTION

The invention relates to composite panels. The invention particularly relates to composite panels prepared using a wax extender.

### BACKGROUND OF THE INVENTION

Wax emulsions are commonly used in the art of preparing composite panels. Waxes provide both water resistance and, in some applications, also an improved surface appearance.

The costs of such waxes can vary with changes to the demand for certain types of hydrocarbon products. For example, when gasoline is in short supply, then refineries tend to run their cracking units at conditions that favor the formation of gasoline and very high molecular weight compounds such as coke. This often results in lowered availability of waxes and resultant higher prices for same. The cost of crude oil and/or natural gas can also increase the cost of the waxes. Natural waxes are subject to cost increases and lower availability due to weather conditions and demand as well.

### SUMMARY OF THE INVENTION

In one aspect, the invention is a composition including a wax and a wax extender.

In another aspect, the invention is an extended wax composition, useful in preparing composite boards, which includes a wax and a wax extender, wherein the wax has a melting point of from about 120° F. (48.9° C.) to about 150° F. (65.6° C.), and wherein the wax extender is a polymer, copolymer or polymer blend of one or more hydrophobes selected from the group consisting of acrylates, methacrylates, polyvinyl acetates, olefins, styrenic emulsion polymers, silicones, polyesters, and combinations thereof, and wherein the wax extender is present at a concentration, in wt % based upon the combined weight of the wax and the wax extender, of from about 1 to about 45%.

In still another aspect, the invention is a composite board prepared using an extended wax composition.

In yet another aspect, the invention is a method of preparing a composite board, the method including using an extended wax to fabricate the composite board.

### DESCRIPTION OF THE INVENTION

Composite boards, also known in the art as composite panels, may be made from wood and have the features of natural wood. When manufacturing composite boards, such as medium density fiber (MDF) boards or particle boards, wood is first ground into wood chips of a desired size. The wood chips are then mixed with a binder in a blender until uniformly blended.

Concrete panels are also, for the purposes of this application, composite boards. Such panels include concrete forms that have fiber reinforcement.

The homogenized mixture for either type of board is formed into a desired shape. The composite board may be coated with polyvinyl chloride (PVC), melamine, metal, foil, impregnated paper, wood veneer that is stained and sealed or polyester to make the composite board decorative and wear resistant and to provide other properties. In some applications, the hardened composite board is then cut to a desired shape and size, and then further processed by cutting, drilling, or edging to create a component part. The composite boards may be used as cabinets, molding, storage units, desks, or other products.

During the last decade oriented strand board (OSB), another form of composite panels, has become a particularly important wood product in the home construction industry. Since its appearance in 1978, OSB has become the most rapidly growing wood-based composite product. OSB is primarily used as a structural panel, which in the past was dominated by softwood plywood.

In some embodiments, the method of the application may be practiced by employing an aqueous emulsion of additives including a hydrocarbon wax. Such hydrocarbon waxes may be selected from any of the commercially known waxes which have a melting point of from about 120° F. (48.9° C.) to about 150° F. (65.6° C.). Typically, the hydrocarbon wax has a melting point of from about 135° F. (57.2° C.) to about 145° F. (62.8° C.). Such waxes are typically of low volatility, exhibiting less than about a 10% loss in weight during standard thermogravimetric analysis.

These waxes are of a relatively high molecular weight, having an average chain length of about 36 or more carbon atoms (C₃₆ or higher). The method of the application may be practiced with slightly lower molecular weight waxes also. The wax component may include any wax known to be useful in the field of emulsions for preparing composite panels. For example, the waxes may be selected from the group including, but not limited to: natural plant-based waxes, animal derived waxes, natural and synthetic mineral waxes, synthetic waxes such as paraffin, carnauba wax, ozocertie wax, montan wax, polyolefin waxes such as polybutylene wax, beeswax, and candelilla wax. In one embodiment, such waxes will have the same general properties as the hydrocarbon waxes described in detail above, namely melting points and oil content.

For the purposes of this application, the term “wax extender” is defined to mean a polymer, copolymer or polymer blends of one or more hydrophobic reactive monomers (hydrophobes). Examples of such materials can include acrylates, methacrylates, polyvinyl acetates, olefins, styrenic emulsion polymers, silicones, polyesters and others. In one embodiment a copolymer of vinyl acetate and one or more hydrophobic reactive monomers (hydrophobes) can be prepared wherein these hydrophobes May have the general formula, but not limited to:

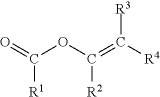

wherein R¹ is a hydrophobic group having from about 4 to about 25 carbons; and R², R³ and R⁴ are independently hydrogen or a methyl group subject to the limitation that at least one of these is hydrogen. In some embodiments, R¹ is an alkyl group having from 7 to about 24 carbons. In other embodiments, R¹ is an alkyl group having from about 8 to about 20 carbons. In still other embodiments, R² is a methyl group and R³ and R⁴ are hydrogen. Some other hydrophobic co-monomers are much simpler in their structure, like ethylene.

Exemplary of such hydrophobes are vinyl neodecanoate, 2-ethylhexyl acrylate, vinyl laurate, 2-ethylhexyl methacrylate, vinyl chloride, dibutyl maleate, ethylene, among others. In an alternative embodiment, more than 2 hydrophobes may be used to prepare the extender. For example, the hydrophobe used in the polymerization may include two or more different compounds within the scope of the general formula above.

In practicing the method of the application, the comonomer may be present at a concentration in weight percent of the weight of the vinyl acetate from about 1 to about 90%. In some embodiments, the comonomer may be present at a concentration in weight percent of the weight of the vinyl acetate of from about 10 to about 60%. In still other embodiments, the comonomer may be present at a concentration in weight percent of the weight of the vinyl acetate of from about 10 to about 30%.

The “wax extender” may be polymerized with a hydrophobe using any method known to be useful in the art for performing such polymerizations. For example, in one embodiment, the polymerization is performed using a free radical type method or process.

In practicing the method of the application, the extender may be present at a concentration in weight percent of the combined weight of the wax and the extender of from about 1 to about 45%. In some embodiments, the extender may be present at a concentration in weight percent of the combined weight of the wax and the extender of from about 10 to about 40%. In still other embodiments, the extender may be present at a concentration in weight percent of the combined weight of the wax and the extender of from about 20 to about 30%.

In some applications of the practice of the method of the disclosure, an extended wax is introduced into the composite board manufacturing process as an aqueous emulsion of the extended wax and the binder resin. Generally, in some embodiments, the amount of extended wax formulation solids does not exceed about 5 wt % of the total weight of the composite board. The actual amount will depend on the composite board's intended use and target properties. In most cases, the extended wax formulation is used in an amount between about 0.1 and about 3.0 wt % based on solids of the wax emulsion solids. For example, in certain embodiments, in fiberboard, 0.3 to 5 wt % can be used; in particleboard, 0.2 to 0.75 wt % can be used; and in oriented strand board, 0.5 to 2 wt % can be used.

As noted above, the composite boards of the application are generally prepared with binder resins, often introduced into the manufacturing process with the extended wax and other additives. Exemplary of such resins are: (meth)acrylic resins, urethane resins, casein, epoxy resins, isocyanate resins, isocyanurate resins, alkyd resins, phenol formaldehyde resins, urea formaldehyde resins, amino acid-based resins, polyester resins, polyvinyl chloride resins, cellulose derivative resins, starch, oily resins, resole and combinations thereof.

In addition to delivering the wax, the aqueous emulsion may be used to introduce other additives to the composite boards. For example, in composites boards used in construction it may be desirable to introduce preservatives. Such preservative may be introduced in amounts effective to inhibit a biological activity, i.e., biological degradation, such as the growth of molds, fungi, bacteria, insects, and the like. Mold release agents, and surface appearance modifiers may also be introduced in this way. The resin and extended wax formulation may be applied to the composite board material in any suitable manner, for example, as atomized drops using a sprayer or spinning disk or by a roll coater.

After incorporation, the composite boards of the application may be formed by compression, for example by pressing in single platen presses, multiple platen presses, continuous presses, special presses for molded particle board parts, or calendar installations, optionally with the simultaneous coating of the boards or moldings in a single step, using veneers, resin impregnated paper, foil, metals and textiles, and the like. Other types of pressing equipment or heating equipment such as radio-frequency devices and steam injection presses can be used. Appropriate pressure is applied to the mat to compress to the desired final thickness for a time sufficient to allow the resin to cure and bond the composite.

The use of the extended waxes of the disclosure allow for the production of composite boards using less wax than a conventional but otherwise similar composite board while maintaining the desirable water resistant properties of the composite boards having much more wax.

The composite boards and panels may be prepared in any way known to those of ordinary skill in the art of preparing such materials to be useful. For example, when the composition includes a reinforcing mat, a method including the use of mat blankets may be used for producing final reinforced products in a speedy and efficient manner.

In one such process, a binder material is added before enclosing the reinforcement blanket within a preform screen. The shaped blanket containing binder material held between the two screens is passed through a narrow oven which directs heat through the screens and through the shaped reinforcement blanket to dry the blanket and to cure the binder material.

In another such process, preform screens are attached to a belted caterpillar-type puller. A roll of blanket reinforcement material is unrolled onto the belted caterpillar-type puller and binder material is added by a suitable applicator. The preform screens are moved together to form the blanket to its desired shape. The preform screens in the belted puller are heated so that extraneous water is driven from the binder material. The binder material cures to hold the reinforcement blanket in its preform shape. The preform final product exits the belted puller and is cut to a desired length at a cutoff station.

In another process, the bottom screen is held stationary and is hinged to the top screen. When the screens are set apart, the reinforcement blanket is positioned between the screens and applied binder material to the blanket in a suitable manner. The blanket is moved into the lower screen as the top screen is closed onto the bottom screen thus shaping the reinforcement blanket. Heat is then injected through the screens to dry and cure the reinforcement blanket. The screens are opened and the completed preform product is removed.

A further process includes direct molding of a final product wherein a roll of reinforcement blanket material is stationed next to the mold. The predetermined length of the blanket is unrolled, cutoff and placed in the mold. The mold has presser rods and as the mold is closed the presser rods first stabilize the reinforcement blanket in the center of the mold. As the mold continues to close the blanket conforms to the shape of the upper and lower mold halves. After the mold is completely closed, a matrix resin is injected into the reinforcement blanket. After a suitable period of time, the mold is opened and the finished preform product is removed.

The extended wax emulsions of the application may be employed in any way known to be useful to those of ordinary skill in the art of making composite panels. The extended waxes of the application may be applied either concurrently with the binder or after the final product panel is removed from the process. For example, in one embodiment, an extended wax emulsion may be applied to the composite matrix concurrently with a binder. However, in some applications, the extended wax emulsions may be added after the board or panel is prepared. In such applications, the emulsions may be added by dipping, but most often they are applied by spraying or flow-coating.

### EXAMPLES

The following examples are provided to illustrate the invention. The examples are not intended to limit the scope of the invention and they should not be so interpreted. Amounts are in weight parts or weight percentages unless otherwise indicated.

### Example 1

A wax extender was prepared by introducing an ethylene vinyl alcohol into a stirred reactor vessel and then combining with potassium persulfate and held for one day. The inside diameter of the vessel was 3.9-inches (9.9-cm). The impeller diameter of the reactor was 1.75-inches (4.45-cm), with three pitched (45°) propellers spaced 2.5-inches apart. The 0.4-inch diameter shaft was run at an RPM of 230.

Vinyl acetate and vinyl neodecanoate are mixed and 5% of the mixture and all of the initial initiator charge are introduced into the reactor at 72° C. The monomer mixture was programmed to flow for 6-hours. The initiator was programmed to flow for 7-hours. The reaction was run between 79-83° C., with potassium persulfate to completion.

The final emulsion was smooth flowing and free of grit. It was 100% compatible with a wax-emulsion. The mixture appeared stable for 3-weeks upon standing before a thin, clear liquid layer began forming at the bottom of the vessel.

### Example 2

A series of 4 wax extenders were made using a method substantially identically to the method of Example 1 with the components shown below in Table 1 except:
i) the initial temperature was 65° C., and 20% of the monomer was added with the initial initiator solution;
ii) the temperature was allowed to rise to 75° C.;
iii) the monomer was programmed to flow for 4 hours and the remaining initiator was programmed to flow for 5 hours; and
iv) the reaction was maintained at 75-76° C. throughout the reaction.

The final emulsion was tested for physical properties which are shown below in Table 2.

The emulsion was used to prepare an oriented strand board. 7/16 inch boards of Aspen flakes, dried to 4.1% moisture content, were prepared. 1.0% wax or wax mixture solids were applied before 3.5% phenol formaldehyde resin solids. The boards were prepared using a press having platen temperatures of 420° F. The emulsion was prepared with a 30:70 mixture of extender to wax. Boards had a target density of 40 lbs/ft3, and an actual board density of 43 lbs/ft3. The boards were tested for: internal bond strength (IB); thickness swell; and water absorption against a control of an otherwise identical emulsion prepared using an un-extended wax. The results are shown below in Table 3.

### Example 3

A wax extender was prepared at large scale by introducing into a reactor an initial charge of ethylene vinyl alcohol, water and sodium bicarbonate. Vinyl acetate and vinyl neodecanoate are mixed and 5% of the mixture and all of the initial initiator charge are introduced into the reactor at 72° C. The monomer mixture was programmed to flow for 6-hours. The initiator was programmed to flow for 7-hours. The reaction was run between 79-83° C., with potassium persulfate to completion, and produced 15830 lbs (7180 Kgs) of Emulsion. The components are shown in Table 4.

The final emulsion was tested for physical properties which are shown below in Table 5.

The blended emulsion was used to prepare an oriented strand board. 7/16 inch boards of Southern Yellow pine flakes, dried to 3-6% moisture content before blending and 5-10% after blending. The emulsion and Phenol-Formaldehyde resin were sprayed on OSB with an atomizer. Wax at a level of ˜0.8-1.0% based on solids of the emulsion and PF resin 2.9% as liquid resin. The boards were prepared using a press having platen temperatures of 410 to 415° F. (210 to 213° C.) and a pressure of 500 psi (35 Kg/cm²). The emulsion was prepared with a 20:80 mixture of extender to wax. Boards had a target density of 40 to 42 lbs/ft³ (641 to 672 Kg/m³). The boards were tested for: internal bond strength (IB); thickness swell; and water absorption against a control of an otherwise identical emulsion prepared using an un-extended wax. The results are shown below in Table 6.

TABLE 1

| | Vinyl | 2-ethylhexyl | | 2-ethylhexyl |
|---|---|---|---|---|
| Component | neodecanoate | acrylate | Vinyl laurate | methacrylate |
| Ethylene | 27.40 | 27.40 | 26.86 | 27.16 |
| Vinyl | | | | |
| Alcohol | | | | |
| Water | 8.33 | 8.32 | 8.18 | 8.28 |
| Sodium | 0.18 | 0.18 | 0.18 | 0.18 |
| bicarbonate | | | | |
| Initial | | | | |
| Initiator | | | | |
| Solution | | | | |
| Potassium | 0.04 | 0.04 | 0.04 | 0.04 |
| Persulfate | | | | |
| Water | 2.20 | 2.21 | 2.16 | 2.20 |
| Remaining | | | | |
| Initiator | | | | |
| Solution | | | | |
| Potassium | 0.20 | 0.20 | 0.20 | 0.21 |
| Persulfate | | | | |
| Water | 17.60 | 17.61 | 17.25 | 17.50 |
| Monomer | | | | |
| Solution | | | | |
| Vinyl | 35.24 | 35.24 | 34.44 | 35.02 |
| Acetate | | | | |
| Hydrophobe | 8.80 | 8.80 | 10.69 | 9.42 |
| Totals | 100.0% | 100.0% | 100.0% | 100.0% |

TABLE 2

| | | | Percent | | | |
|---|---|---|---|---|---|---|
| | | Average | Pan | | | Free |
| | | Particle | Dried | Grit | | VAM |
| | | Size | Solids | content | Tg | (%) GC - |
| System | pH | (nm) | (%) | (%) | (° C.) | Headspace |
| Vinyl | 4.76 | 775 | 46.79 | 0.01 | 27.49 | 0.35 |
| neodecanoate | | | | | | |
| 2-ethylhexyl | 4.69 | 1219 | 45.77 | 0.01 | 19.9 | 0.23 |
| acrylate | | | | | | |
| Vinyl laurate | 4.79 | 813 | 47.61 | 0.01 | 26.26 | 0.18 |
| 2-ethylhexyl | 4.59 | 1224 | 47.37 | BDL* | 19.2 | 0.17 |
| methacrylate | | | | | | |

TABLE 3

| | | Thickness | Water |
|---|---|---|---|
| System | IB (lbs) | Swell | Absorption % |
| Control | 132.6 | 16.4 | 28.2 |
| Vinyl | 190.9 | 19.2 | 37.8 |
| neodecanoate | | | |
| 2-ethylhexyl | 123.1 | 14.9 | 29.4 |
| acrylate | | | |
| Vinyl laurate | 131.4 | 15.8 | 33.7 |
| 2-ethylhexyl | 113.9 | 17.4 | 33.6 |
| methacrylate | | | |

TABLE 4

| | Vinyl |
|---|---|
| Component | neodecanoate |
| Ethylene Vinyl | 27.40 |
| Alcohol | |
| Water | 8.33 |
| Sodium | 0.18 |
| bicarbonate | |
| Initial | |
| Initiator | |
| Solution | |
| Potassium | 0.04 |
| Persulfate | |
| Water | 2.20 |
| Remaining | |
| Initiator | |
| Solution | |
| Potassium | 0.20 |
| Persulfate | |
| Water | 17.60 |
| Monomer | |
| Solution | |
| Vinyl Acetate | 35.24 |
| Hydrophobe | 8.80 |
| Totals | 100.0% |

TABLE 5

| | | | Percent | |
|---|---|---|---|---|
| | | Average | Pan | Brookfield |
| | | Particle | Dried | Viscosity |
| System | pH | Size(nm) | Solids(%) | cps |
| PVAc | 4.6 | 2.15 | 46.18 | 1500 |
| emulsion | | | | |

TABLE 6

| | | | Water |
|---|---|---|---|
| | | Thickness | Absorption |
| System | IB (lbs) | Swell | % |
| Control | 21.7046 | 30.2672 | 81.5589 |
| Wax/PAVC | 30.6225 | 33.8725 | 82.4785 |
| 80/20 | | | |

We claim:

1. An extended wax composition, useful in preparing composite boards, the extended wax comprising a wax and a wax extender,
wherein the wax has a melting point of from about 120° F. (48.9° C.) to about 150° F. (65.6° C.),
wherein the wax extender is a polymer, copolymer or polymer blend of one or more hydrophobes selected from the group consisting of acrylates, methacrylates, polyvinyl acetates, olefins, styrenic emulsion polymers, silicones, polyesters, and combinations thereof, and
wherein the wax extender is present at a concentration, in wt % based upon the combined weight of the wax and the wax extender, of from about 1 to about 45%.

2. The composition of claim 1 wherein the wax extender is a copolymer of vinyl acetate and one or more hydrophobes having the formula: 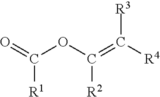
wherein R¹ is a hydrophobic group having from about 4 to about 25 carbons, and R², R³ and R⁴ are independently hydrogen or a methyl group subject to the limitation that at least one of these is hydrogen. In some embodiments, R¹ is an alkyl group having from 7 to about 24 carbons.

3. The composition of claim 1 wherein the wax extender is a copolymer of vinyl acetate and a hydrophobe selected from the group consisting of vinyl neodecanoate, 2-ethylhexyl acrylate, vinyl laurate, 2-ethylhexyl methacrylate, vinyl chloride, dibutyl maleate, ethylene, and combinations thereof.

4. The composition of claim 2 wherein the hydrophobe is present at a concentration, in a wt %, based on the weight of the vinyl acetate, from about 1 to about 90%.

5. A method of preparing a composite board comprising introducing into a composite board manufacturing process an aqueous emulsion comprising the extended wax of claim 1 and a binder resin, wherein an amount of extended wax solids does not exceed about 5 wt % of the total weight of the composite board.

6. The method of claim 5 wherein the composite board comprises wood.

7. The method of claim 6 wherein the composite board is fiberboard and the amount of extended wax solids is about 0.3 to about 5 wt % based on the total weight of the fiberboard.

8. The method of claim 6 wherein the composite board is particle board and the amount of extended wax solids is about 0.2 to about 0.75 wt % based on the total weight of the particle board.

9. The method of claim 6 wherein the composite board is oriented strand board and the extended wax composition is present in an amount of about 0.5 to about 2 wt % based on the total weight of the oriented strand board.

10. The method of claim 5 wherein the binder resin is selected from the group consisting of (meth)acrylic resins, urethane resins, casein, epoxy resins, isocyanate resins, isocyanurate resins, alkyd resins, phenol formaldehyde resins, urea formaldehyde resins, amino acid-based resins, polyester resins, polyvinyl chloride resins, cellulose derivative resins, starch, oily resins, resole and combinations thereof.

11. A composite board prepared using the extended wax composition of claim 1.

12. The composite board of claim 10, wherein the composite board comprises wood.
